(19) United States
(12) Patent Application Publication
(10) Pub. No.: US 2020/0030957 A1
(43) Pub. Date: Jan. 30, 2020

(54) POWER TOOL AND ACCESSORY SYSTEM

(71) Applicant: Black & Decker Inc., New Britain, CT (US)

(72) Inventor: Tim HEIMRICH, Bad Camberg (DE)

(21) Appl. No.: 16/450,312

(22) Filed: Jun. 24, 2019

(30) Foreign Application Priority Data
Jul. 25, 2018 (GB) 1812133.5

(51) Int. Cl. B25D 17/20; B25D 16/00; B25D 11/06; H02K 7/14; H02J 50/10; H02K 11/00

(52) U.S. Cl. CPC B25D 17/20; B25D 16/00; B25D 11/064; B23Q 11/0046; H02J 50/10; H02K 11/0094; H02K 7/145

(57) ABSTRACT

A power tool and accessory system is described that comprises a power tool such as hammer drill and an accessory such as dust extractor. In order to provide electrical power to the drive motor of the dust extractor, a first induction coil is disposed in the hammer drill and is electrically connected to the power supply of the hammer drill. A second induction coil is disposed in the dust extractor at a location in which, when the hammer drill and dust extractor are connected, current through the first induction coil induces a voltage in the second induction coil through inductive coupling. As a consequence, the drive motor of the dust collector is powered by inductive power transfer from the electrical power source of the hammer drill.

### CROSS-REFERENCE TO RELATED APPLICATIONS

This application claims priority, under 35 U.S.C. § 119, to UK Patent Application No. 18 121 33.5 filed Jul. 25, 2018.

### FIELD

The present invention relates to a power tool and accessory system, and relates particularly, but not exclusively, to a power tool and accessory system comprising induction coils for the wireless transfer of power.

### BACKGROUND

Many types of power tool have mountable accessories which can be used to improve user experience and facilitate use of the power tool. For example, power tools which create dust and debris such as drills, hammer drills and many types of saw may have attachable vacuum dust extractors which draw in dust and debris to reduce the amount of dust and debris deposited around the area being worked on and also to reduce the likelihood of the user inhaling dust. Other types of power tool accessories include lights and lasers for lighting and alignment.

EP1245330 describes a hammer drill having a dust extraction accessory. The dust extraction accessory is mountable to the front of the hammer drill and comprises a vacuum inlet that extends around the bit of the hammer drill to draw in air containing dust produced from the hammer drilling operation. The dust is then filtered and cleaned air exhausted. Power for the fan of the dust extractor is provided by a mechanical coupling between the spindle of the drive motor of the hammer drill and the fan drive shaft. Such a mechanical connection suffers from the drawback that if dust becomes trapped in the mechanical interface, the dust extractor can malfunction.

EP1459842 describes a similar type of hammer drill and dust collection accessory. However, rather than a mechanical drive connection between the drill motor shaft and the suction fan of the dust collector, the dust collector comprises its own motor which is powered by an electrical connection between the dust collector and the hammer drill. This type of system suffers from the drawback that if the electrical connectors are damaged, for example if a terminal is bent out of shape, the dust collector is rendered inoperable.

DE10 2007000826A1 and EP2174749B1 also disclose dust extractors for hammer drills which use the electrical power provided by the power tool to drive the dust extractor drive motors.

### SUMMARY

Preferred embodiments of the present invention seek to overcome the above disadvantages of the prior art.

According to an aspect of the present, there is provided a power tool comprising a source of electrical power, an electric motor for driving a tool output, and a first induction coil configured to wirelessly transmit electrical power to a second induction coil disposed in a tool accessory to power an accessory output of the tool accessory, where the tool accessory is mountable to the power tool.

This provides the advantage of a power tool that does not rely on a physical mechanical or electrical interconnection to power a mountable accessory. By eliminating a physical connection, the likelihood of malfunction is significantly reduced. This also provides the advantage that many types of accessory can be coupled to the same power tool. For example, accessories such as lights and lasers which do not require mechanical power can be coupled using a common wireless power connection. Generic accessories can also be produced which can be powered by different models in a range of for example hammer drills.

The power tool may be a hammer drill and the tool accessory may be one of a dust extractor, a light or a laser.

According to another aspect of the present invention, there is provided a power tool accessory mountable to a power tool, the power tool accessory comprising an accessory output, and a second induction coil configured to receive electrical power wirelessly transmitted from a first induction coil of a power tool in use to power the accessory output.

This provides the advantage of a power tool accessory that does not rely on a physical mechanical or electrical interconnection for power. By eliminating a physical connection, the likelihood of malfunction is significantly reduced. This also provides the advantage that many types of accessory can be coupled to the same power tool. For example, accessories such as lights and lasers which do not require mechanical power can be coupled using a common wireless power connection. Generic accessories can also be produced which can be powered by different models in a range of for example hammer drills.

According to a further aspect of the present invention, there is provided a power tool and accessory system comprising: a power tool including a source of electrical power, an electric motor for driving a tool output, and a first induction coil configured to wirelessly transmit electrical power; and a tool accessory mountable to the power tool including an accessory output, and a second induction coil configured to receive electrical power wirelessly transmitted from said the induction coil to power the accessory output.

This provides the advantage of a power tool and accessory system that does not rely on a physical mechanical or electrical interconnection to power the accessory. By eliminating a physical connection, the likelihood of malfunction is significantly reduced. This also provides the advantage that many types of accessory can be coupled to the same power tool. For example, accessories such as lights and lasers which do not require mechanical power can be coupled using a common wireless power connection. Generic accessories can also be produced which can be powered by different models in a range of for example hammer drills.

The power tool may be a hammer drill and the tool accessory may be one of a dust extractor, a light or a laser.

### BRIEF DESCRIPTION OF THE DRAWINGS

Preferred embodiments of the present invention will now be described, by way of example only and not in any limitative sense, with reference to the accompanying drawings in which:

FIG. 1 is a perspective view of a power tool and accessory system embodying the present invention;

FIG. 2 is a side view of the dust extractor accessory of the system of FIG. 1;

FIG. 3 is a side view of a power tool of the system of FIG. 1; and

FIG. 4 is a schematic of the induction coupling of the system of FIG. 1.

### DETAILED DESCRIPTION

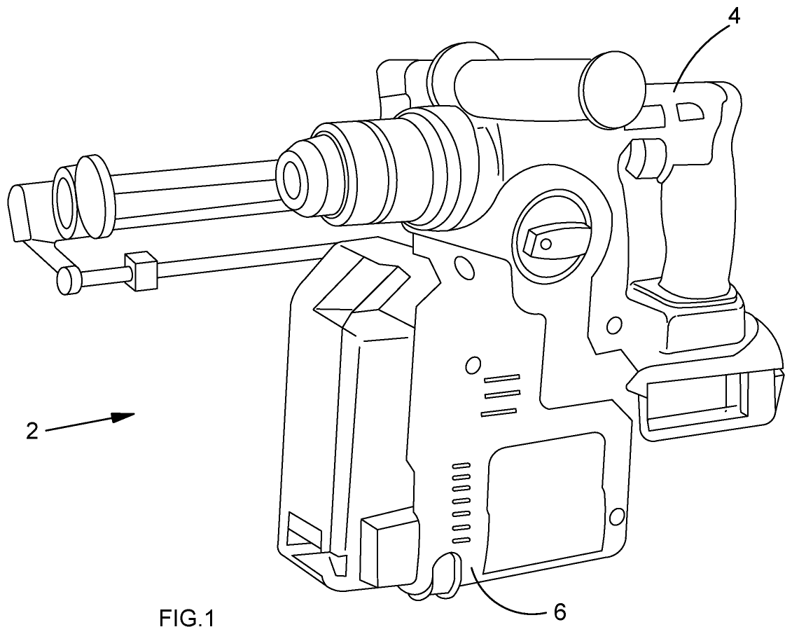

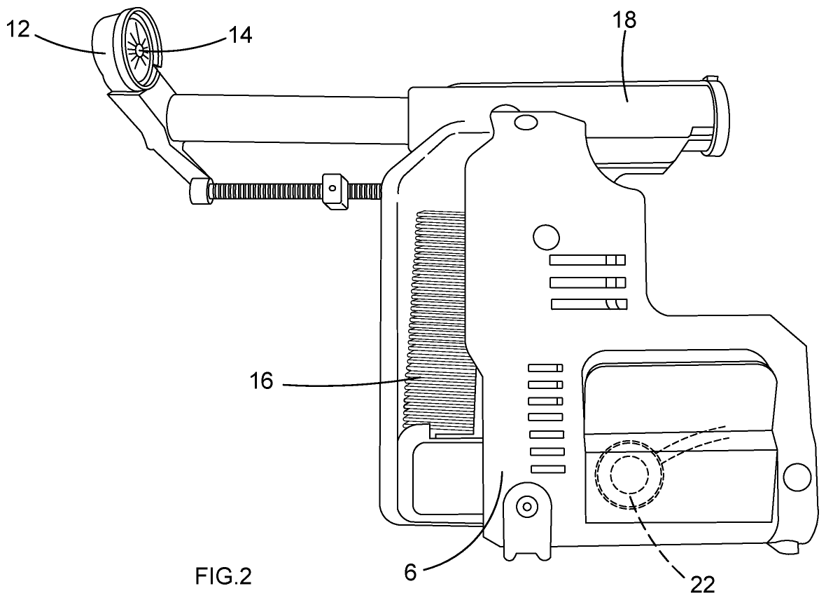

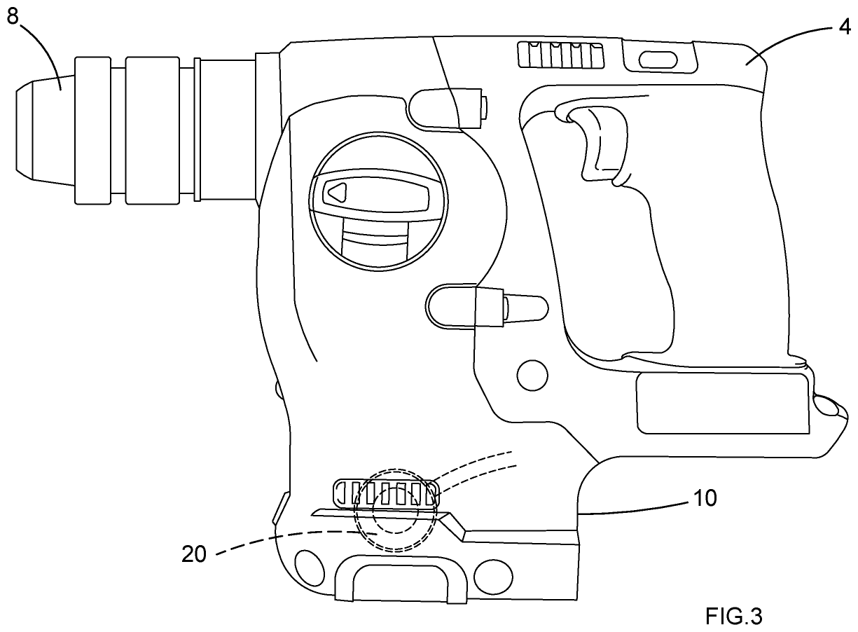

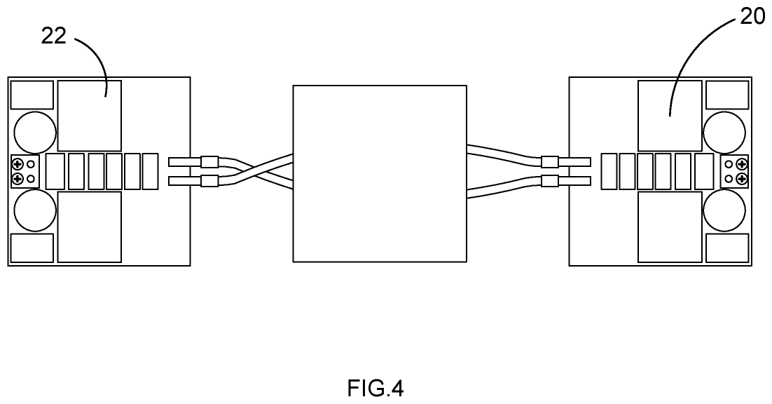

Referring to FIGS. 1 to 4, a power tool and accessory system 2 comprises a power tool such as hammer drill 4 and an accessory such as dust extractor 6. Hammer drill 4 comprises an electric motor (not shown) to drive a rotary spindle output 8. A source of electrical power such as battery pack 10 is provided, although the hammer drill 4 could also be powered by a corded connection to mains electricity. Hammer drill 4 is able to drive a bit (not shown) in both a reciprocating and rotary manner as will be familiar to persons skilled in the art.

Dust extractor 6 comprises an inlet 12 comprising an aperture 14 through which a bit of hammer drill 4 is arranged to project. Dust extractor 6 also comprises an electric motor (not shown) to drive a fan (not shown) to draw dust laden air into inlet 12. A filter 16 is provided to filter dust from air drawn in through inlet 12. The dust extractor 6 is mountable to hammer drill 4 using a mechanical interface which includes projection 18 which is slideably received in a corresponding slot (not shown) of hammer drill 4. Latching means (not shown) is also provided to releaseably lock the dust extractor 6 to the hammer drill 4.

In order to provide electrical power to the drive motor of the dust extractor 6, a first induction coil 20 is disposed in the hammer drill 4 and is electrically connected to the power supply of the hammer drill. A second induction coil 22 is disposed in the dust extractor 6 at a location in which when the hammer drill 4 and dust extractor 6 are connected as shown in FIG. 1, current through the first induction coil 20 induces a voltage in the second induction coil 22 through inductive coupling. As a consequence, the drive motor of the dust collector 6 is powered by inductive power transfer from the electrical power source of the hammer drill 4.

It should be understood that the hammer drill and dust extractor system is only one example of a power tool and accessory system that can use wireless power transfer by inductive coupling between the first and second induction coils 20 and 22. Other accessories such as lasers and lights can use such inductive coupling, as well as other power tools such as saws and routers.

It will be appreciated by persons skilled in the art that the above embodiment have been described by way of example only and not in any limitative sense, and that various alterations and modifications are possible without departure from the scope of the invention as defined by the appended claims.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

1. A power tool comprising:
a source of electrical power;
an electric motor for driving a tool output; and
a first induction coil configured to wirelessly transmit electrical power to a second induction coil disposed in a tool accessory to power an accessory output of the tool accessory, wherein said tool accessory is mountable to said power tool.

2. A power tool according to claim 1, wherein the power tool is a hammer drill and said tool accessory is one of a dust extractor, a light or a laser.

3. A power tool accessory mountable to a power tool, the power tool accessory comprising:
an accessory output; and
a second induction coil configured to receive electrical power wirelessly transmitted from a first induction coil of a power tool in use to power said accessory output.

4. A power tool and accessory system comprising:
a power tool comprising: a source of electrical power; an electric motor for driving a tool output; and a first induction coil configured to wirelessly transmit electrical power; and
a tool accessory mountable to said power tool, the tool accessory comprising: an accessory output; and a second induction coil configured to receive electrical power wirelessly transmitted from said first induction coil to power said accessory output.

5. A system according to claim 4, wherein the power tool is a hammer drill and said tool accessory is one of a dust extractor, a light or a laser.
